(19) United States
(12) Patent Application Publication
(10) Pub. No.: US 2022/0005026 A1
(43) Pub. Date: Jan. 6, 2022

(54) SYSTEM AND METHOD FOR IMPLEMENTING A MARKET DATA HUB WITH DIGITAL RIGHTS MANAGEMENT

(71) Applicant: JPMorgan Chase Bank, N.A., New York, NY (US)

(72) Inventor: Ilya SLAVIN, Allen, TX (US)

(21) Appl. No.: 17/340,526

(22) Filed: Jun. 7, 2021

Related U.S. Application Data
(60) Provisional application No. 63/046,862, filed on Jul. 1, 2020.

(51) Int. Cl. G06Q 20/38; G06F 16/27; H04L 29/06

(52) U.S. Cl. CPC G06Q 20/389; H04L 63/20; G06F 16/27

(57) ABSTRACT

The invention relates generally to a system and method for implementing a multi-dealer market data distribution system with digital rights management. An embodiment of the present invention is directed to a Market Data Hub with Distributed Ledger Technology. The innovative system and method are directed to implementing a Quorum Blockchain Node that manages contributed content and allows for custom analytics, alerting, reporting, machine learning interfaces, etc., while preserving entitlements controls and privacy controls specific to participants.

### CROSS REFERENCE TO RELATED APPLICATIONS

The application claims priority to U.S. Provisional Application 63/046,862 (Attorney Docket No. 72167.001881), filed Jul. 1, 2020, the contents of which are incorporated by reference herein in their entirety.

### FIELD OF THE INVENTION

The invention relates generally to a system and method for implementing a multi-dealer market data distribution system with digital rights management.

### BACKGROUND OF THE INVENTION

Large financial companies contribute a large amount of information to information brokers to be distributed outside their firms. This information includes research reports, client statements, trade confirmations, responses to quotes, etc. One example of actively moving and varied category is market data. Data in this category may include index valuations, indicative quotes, reference data for new securities, indications of interest, etc. Information changes at a variable pace per financial security and can move quickly. Other changing data and data at rest may include files, research reports, reference data, etc.

In the age of information, financial institutions are concerned with entitlements controls, methods of consumption, cross-company content sharing, dangers of disclosure, etc. Over the course of the last decades, a small number of entrenched vendors have built data monopolies in specific asset classes and have limited incentives to innovate in the space. Because data is so sensitive, financial institutions are not willing to entrust others with the full range of their data.

These and other drawbacks exist.

### SUMMARY OF THE INVENTION

According to one embodiment, the invention relates to a system that implements a multi-dealer market data distribution with distributed ledger technology. The system comprises: an input that receives information from a plurality of sources; a secure communications platform that facilitates communication with a plurality of member contributors and receivers; and a distributed ledger node that communicates with a network of distributed nodes where each node has a set of privacy controls and is further configured to perform the steps of: receiving, via the input, market data from a plurality of data producers; applying an entitlement control that specifies how the market data can be accessed and used in generating one or more securities; and providing access to the market data pursuant to the entitlement control to one or more authorized recipients while preserving the set of privacy controls.

According to another embodiment, the invention relates to a method that implements a multi-dealer market data distribution with distributed ledger technology. The method comprises the steps of: establishing a secure communications platform that facilitates communication with a plurality of member contributors and receivers; implementing a distributed ledger node that communicates with a network of distributed nodes where each node has a set of privacy controls; receiving, via an input, market data from a plurality of data producers, wherein the input receives information from a plurality of sources; applying an entitlement control that specifies how the market data can be accessed and used in generating one or more securities; and providing access to the market data pursuant to the entitlement control to one or more authorized recipients while preserving the set of privacy controls.

An embodiment of the present invention is directed to a specially programmed computer system comprising one or more computer processors, interactive interfaces, electronic storage devices, and networks. The computer implemented system, method and medium described herein provide unique advantages to entities, organizations and other users, according to various embodiments of the invention. Content owners may be asked to submit their content to a tool that limits visibility of the data by recipient organizations. However, these tools generally have no bearing on how this content may be used in generating derived data, such as indexes. While control may be simulated by creating a separate Quorum node that handles generation of synthetic instruments, these controls are restrictive and provide contributors with very limited controls (i.e., all or none) over what data is used in derivation and how. The innovative system provides transparency to otherwise restricted pricing and other market data. For many users, an embodiment of the present invention seeks to reduce spend on market data.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary system architecture, according to an embodiment of the present invention.

FIG. 2 is an exemplary flowchart, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

Digital Rights Management (DRM) technologies, such as Open Digital Rights Language (ODRL), allow content owners to maintain granular controls not only over what information is permitted to be used in derivation, regardless of location, but also provide a vehicle to specify terms that may be attached to the finished product (which may be in combination with other providers' terms). ODRL represents a policy expression language that provides a flexible and interoperable information model, vocabulary, and encoding mechanisms for representing statements about the usage of content and services. ODRL is one exemplary application and other Rights Expression Languages (RELs) may be applied in accordance with the various embodiments of the present invention.

An embodiment of the present invention is directed to an auction-style process, where recipients of data may request specific products. Providers may “bid” on the products and further identify conditions they would require. A matching engine may then check which terms are acceptable to the various participants. An embodiment of the present invention is directed to implementing a marketplace for financial content that does not exist today. This provides the ability to re-inject free and competitive market economics in a locked-in field with few incumbent vendors exercising monopoly powers.

An embodiment of the present invention may be implemented in a Market Data Hub by extending rights management of content to data providers. Market Data Hub may use a distributed ledger platform, such as a Quorum implementation of Blockchain. Quorum represents an enterprise-ready distributed ledger and smart contract platform. Quorum may be implemented for applications requiring processing of private transactions within permissioned participants. While the various embodiments of the present invention are described within the context of Quorum and Blockchain, other distributed ledger platforms, including other implementations of Blockchain and technologies may be implemented. Additional details concerning Market Data Hub are provided in U.S. patent application Ser. No. 16/845,156, filed Apr. 10, 2020 (Attorney Docket Number: 72167.001855), entitled “System and Method for Implementing A Market Data Hub via Distributed Ledger Technology,” which claims priority to U.S. Provisional Application No. 62/833,019, filed Apr. 12, 2019 (Attorney Docket Number: 72167.001708), the contents of which are incorporated by reference herein in their entirety.

An embodiment of the present invention enables data producers to create fine-grained entitlements of data. An embodiment of the present invention may provide various entitlements that limit who can see the data or not see the data and then control the use of the data. For example, a data provider may specify that a security can be used for synthetic security generations, such as an index, a benchmark, and/or other algorithmically generated security. An embodiment of the present invention enables data providers and other users to base actions, permissions and/or restrictions on a specific security. Accordingly, with an embodiment of the present invention, a requester may specify rights associated with a particular security.

According to an exemplary illustration, a first financial institution may want to publish data into an index that another entity, such as an automated process inside Market Data Hub, may generate. A second financial institution may have a different set of requirements for which clients can see the information and/or how much they want to charge for the information (which may be different from what the first financial institution may want to charge).

An embodiment of the present invention enables users to provide a rich level of detail that may be attached to content, e.g., specific securities, etc. Accordingly, with an embodiment of the present invention, a data producer or provider may publish information and impose specific and granular entitlements on the information.

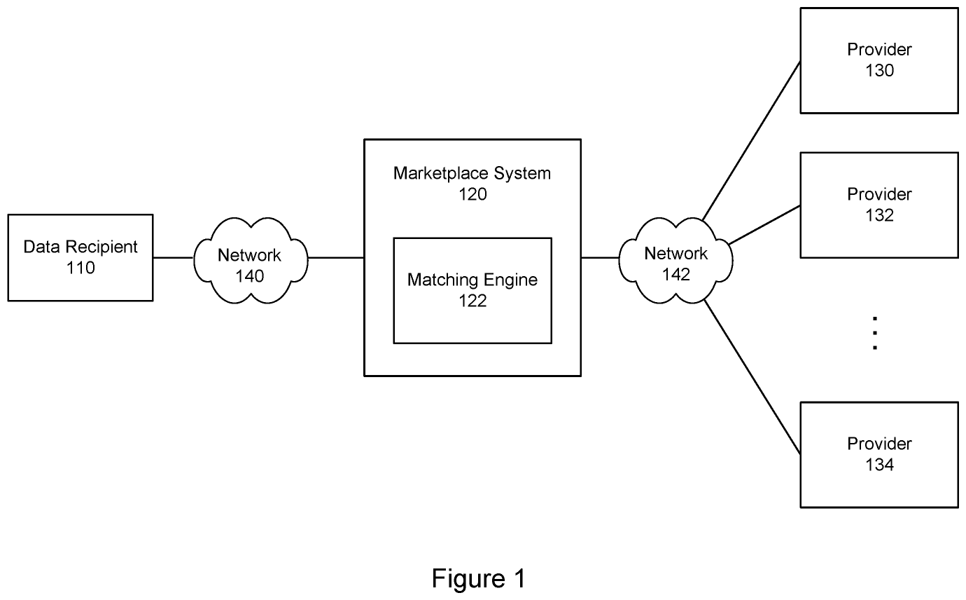

FIG. 1 is an exemplary system diagram of a marketplace, according to an embodiment of the present invention. As shown in FIG. 1, an exemplary marketplace may have an auction-style implementation. In the example of FIG. 1, recipients of data (represented by Data Recipient 110) may submit a request for specific products, such as a security. This request may be communicated via network 140 to a Marketplace System 120. Providers 130, 132, 134 may then bid on the request via Network 142. Providers may also specify conditions and/or terms that may be required. Marketplace System 120 may include a Matching Engine 122 that automatically determines which terms are acceptable to a customer, e.g., data recipient, as well as any variances/differences, etc.

For example, Data Recipient 110 may represent a hedge fund, asset management type of entity, etc. As shown in FIG. 1, Data Recipient 110 may submit a request that identifies a specific type of security. In this example, Data Recipient 110 may not be able to generate the security due to regulatory obligations and therefore that Data Recipient 110 may seek to engage a Data Publisher to generate the specific type of security. This may be due to benchmark obligations and other restrictions/reasons. In this example, Data Recipient 110 may have a set of predefined protocols to request the security and further specify where they are willing to differ. Based on the request, data providers may submit a bid which may indicate they are willing to create the requested security but further request one or more parameters, such as a particular type of rights, a maximum amount they are willing to pay, etc. An embodiment of the present invention may apply a matching engine to determine an optimal or best bid for the participant or data recipient. The matching engine may further identify variances and propose one or more updated parameters and/or conditions as well as other resolution or compromise.

According to an embodiment of the present invention, Marketplace System 120 may enable interactions between participants to reach an agreement on additional parameters, terms, conditions, etc. This may be supported by an interactive interface or other communication mechanism.

According to another example, a participant bank may make markets, such as rates securities, which may be illiquid. By regulatory obligations, the same bank would have to compare its trades against an industry benchmark. With an embodiment of the present invention, the bank may define what security it needs to create and how the information can be used. For example, the request may include a benchmark created in a particular fashion (e.g., an index). The request may also define an acceptable usage pattern. In this example, the bank may want to use the information for regulatory reporting; the bank may want to derive data from it; the bank may want to generate published reports to clients in an electronic database, etc. In response to the request, various participants who make markets in these securities may submit bids that provide their rights, requirements and/or prohibitions if they were to generate this type of security. The matching engine may then determine what is acceptable to the client compared to what producers are willing to provide. In an example above, where the market is highly illiquid, the bank that is requesting an index to be created may “bid” on its own request and find no other bidders. That process would be very transparent, however, due to built-in benefits of Blockchain technology. Therefore, a bank's regulatory needs may be satisfied without having to send their trade data to a third party information broker, just to buy the same back as an index.

Bidder participants may be determined based on quorum publishing. For example, a client bank may exclude one or more particular organizations. Other restrictions and filters may be applied. For example, a participant may explore a new market and not want competitors to know that the participant is doing this. In this example, the client bank may publish the request and then exclude competitors.

An embodiment of the present invention is directed to applying digital rights management to outbound data. Digital rights management may identify who can access the data, under what conditions and specific requirements, etc. The outbound data may be encrypted and further require an encryption key from the publisher thereby ensuring compliance with Digital Rights Management (DRM) rules. For example, the decryption key may be only provided if data is being accessed in accordance with DRM rules. Other security restrictions may be applied. Outbound data may include reference data which does not change over time or streaming content.

An embodiment of the present invention is directed to creating trust between a distributing user and a recipient user and further ensures that the data is accessed and used in accordance with agreed upon rights.

An embodiment of the present invention may be implemented in various ways. For example, an organization may own the innovations described herein that read data from quorum, apply ODRL principles, create securities and publish them back while respecting the publisher's rights. According to another example, an embodiment of the present invention may build into a distributed market data hub where entities have their own quorum node and accordingly process data. The matching system of an embodiment of the present invention may be built-in and distributed to various participants where each node may generate synthetic instruments. Because such distribution is generally asynchronous, this may be applied to less liquid securities, for example.

An embodiment of the present invention is directed to vendor specific distribution of data (e.g., research distribution) through a market data hub. For example, the market data hub may implement local bridges to various vendors. An integrated console may then serve as an interface to various client end users.

An embodiment of the present invention may be built around an application program interface (API) where digital rights are distributed in a programmatic manner. In this example, a consumer of rights (such as a bank, financial institution, etc.) may use digital rights for a particular function or action.

An embodiment of the present invention is directed to programmatically acquiring necessary rights from participants based on the structure of the synthetic security it is trying to create. For example, an embodiment of the present invention may be directed to an interface with a Marketplace System that identifies missing rights and then programmatically seeks to acquire the missing rights. For example, the Marketplace System may determine that it needs information from four participants and further determine that the permissions from three out of the four participants have been obtained. An embodiment of the present invention may recognize the missing element and seek to acquire the rights from the fourth participant. The marketplace system is deterministic in that it is identifying missing elements based on an algorithm. For example, an embodiment of the present invention may determine whether it has the right type of rights to perform what it needs to perform and then identify any gaps in a programmatic manner.

An embodiment of the present invention seeks to create a synthetic instrument for the purpose of distribution to customers in accordance with the associated rights. The system may identify the data that is needed or missing and then interrogate the ODRL for the necessary information. Additional details concerning ODRL are provided in U.S. patent application Ser. No. 16/563,106, filed Sep. 6, 2019 (Attorney Docket Number: 72167.001770), entitled “System and Method for Implementing Market Data Rights Enforcement,” and corresponding International Application No. PCT/US2020/048378, filed Aug. 28, 2020 (Attorney Docket Number: 72167.001894), the contents of which are incorporated by reference herein in their entirety.

An embodiment of the present invention may be implemented in various ways including as a distributed system where nodes may execute predefined series of code. Also, a centralized entity may function as a caretaker of an infrastructure without overseeing data migration. In this exemplary implementation, an interactive interface may be provided to facilitate communication between providers and data recipients. This implementation may be supported by a third party entity, such as a caretaker.

An embodiment of the present invention is directed to validating constituent rights for product generation. This may further include validating that the product can be distributed to data recipients with a corresponding set of digital rights attached in a format that the data recipients can then process. The product may be represented in various forms, such as a complicated security, index, etc. For example, index research may take data from variety of hundreds of different sources to then generate a complicated security that may then be sold as an index. According to another example, the product may also represent research analysis on particular companies. This may represent financial standing and other research information.

Referring to FIG. 1, Data Recipient 110 may receive a final product from Marketplace System 120 with a corresponding set of digital rights. Depending on a prior agreement, the digital rights may be required or optional to enforce. In addition, an embodiment of the present invention may require an enforcement of the digital rights where the actual content may be encrypted in addition to enforcing the rights. In this example, Data Recipient 110 may be required to use a public key infrastructure to request keys to decrypt the content for a duration of a session.

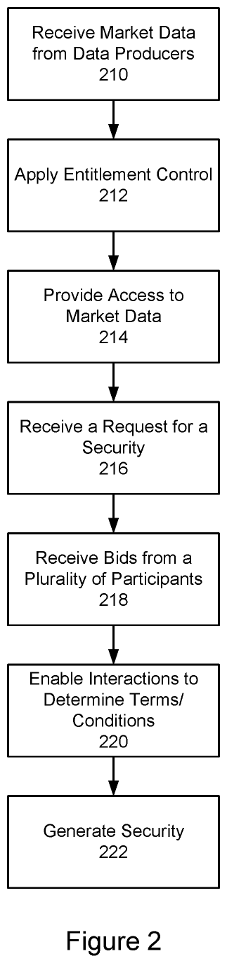

FIG. 2 is an exemplary flowchart, according to an embodiment of the present invention. At step 210, market data may be received from a plurality of data producers. At step 212, entitlement controls may be applied to the market data. At step 214, an embodiment of the present invention may provide access to the market data pursuant to the corresponding entitlement controls. At step 216, a request for a security may be received. The request may be from a data recipient and may relate to a new security or other product. At step 218, one or more bids from a plurality of participants may be received. At step 220, an embodiment of the present invention may enable interactions to determine one or more terms, conditions and/or other factors associated with the request. At step 222, the security may be generated pursuant to the agreed upon terms, conditions, factors, etc. While the process of FIG. 2 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

An exemplary illustration may involve an index generation. This generally involves a formulaic process with a specific list of constituents and set of weights that are applied to an algebraic formula where a single number or representation is generated to represent the formula. To generate this, data from constituents (e.g., Providers 130, 132, 134) may be needed. In response to the constituents submitting information, an embodiment of the present invention may provide the rights to be distributed with the resulting information. Matching Engine 122 may then build the particular index for the constituents and then determine whether the rights from the providers are available to build the index. For the index, there may be a corresponding set of rights. An embodiment of the present invention may determine that Providers 130 and 134 have granted the rights but Provider 132 has not. This may result in an error and an inability to build the index. According to another scenario, an embodiment of the present invention may identify the missing right and initiate a process to obtain the rights from Provider 132. An embodiment of the present invention may initiate a prescribed methodology to obtain the missing right within a set of parameters including a predetermined budget and/or other conditions, restrictions, guidelines, etc. This may involve seeking to purchase the rights from Provider 132 through an agreement that falls within the set of parameters. An embodiment of the present invention may then approve the rights from Provider 132 and then the resulting product may be made available for consumption by one or more data recipients, represented by 110.

Marketplace System 120 enables recipients to request particular securities to be created. Data recipient may make a request and provide the necessary information. This may include a formula, list of constituents, list of weights, etc. For example, data recipient 110 may indicate parameters, such as price or price range for the right to receive the security, such as an index. Marketplace System 120 may then use that as an input to determine whether to acquire the necessary rights. This may be an interactive conversation or interaction where Marketplace System 120 may indicate that the data recipient has the rights. Providers (represented by 130, 132, 134) may establish that they want a particular chargeback structure and then send price information to Data Recipient 110. For example, Marketplace System 120 may support an interactive conversation where it may indicate that one or more rights are missing. Marketplace System 120 may then request pricing input from Providers 130, 132, 134. Data Recipient 110 may then be asked whether or not they are willing to pay more. If Data Recipient 110 is willing to pay more, an embodiment of the present invention may establish a digital contract to capture the agreed upon terms and interaction.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system that implements a multi-dealer market data distribution with distributed ledger technology, the system comprising:
an input that receives information from a plurality of sources;
a secure communications platform that facilitates communication with a plurality of member contributors and receivers; and
a distributed ledger node that communicates with a network of distributed nodes where each node has a set of privacy controls and is further configured to perform the steps of:
receiving, via the input, market data from a plurality of data producers;
applying an entitlement control that specifies how the market data can be accessed and used in generating one or more securities; and
providing access to the market data pursuant to the entitlement control to one or more authorized recipients while preserving the set of privacy controls.

2. The system of claim 1, wherein providing access to the market data involves using encryption to secure adherence to one or more Digital Rights Management (DRM) rules.

3. The system of claim 2, wherein the one or more Digital Rights Management (DRM) rules is expressed through Open Digital Rights Language (ODRL).

4. The system of claim 1, the distributed ledger node is further configured to perform the step of:
enabling, via a matching engine, a participant to request a new security with a set of rights specifications and further enabling the plurality of data producers to bid on creating the new security.

5. The system of claim 1, the distributed ledger node is further configured to perform the step of:
automatically, via a computer processor, generating one or more derived or synthetic securities while respecting the rights of each of the plurality of data producers as expressed by one or more Digital Rights Management (DRM) rules.

6. The system of claim 4, wherein the bid from at least one of the plurality of data producers comprise one or more of: rights, requirements and prohibitions relating to creating the new security.

7. The system of claim 4, wherein the matching engine is configured to identify one or more missing rights.

8. The system of claim 7, in response to the one or more missing rights, the matching engine programmatically acquires the one or more missing rights.

9. The system of claim 4, wherein the matching engine enables one or more interactions between the participant and the plurality of data producers to determine one or more terms and conditions associated with the request for the new security.

10. The system of claim 9, wherein the matching engine generates a digital contract to capture the one or more terms and conditions.

11. A method that implements a multi-dealer market data distribution with distributed ledger technology, the method comprising the steps of:
establishing a secure communications platform that facilitates communication with a plurality of member contributors and receivers;
implementing a distributed ledger node that communicates with a network of distributed nodes where each node has a set of privacy controls;
receiving, via an input, market data from a plurality of data producers, wherein the input receives information from a plurality of sources;
applying an entitlement control that specifies how the market data can be accessed and used in generating one or more securities; and
providing access to the market data pursuant to the entitlement control to one or more authorized recipients while preserving the set of privacy controls.

12. The method of claim 11, wherein providing access to the market data involves using encryption to secure adherence to one or more Digital Rights Management (DRM) rules.

13. The method of claim 12, wherein the one or more Digital Rights Management (DRM) rules is expressed through Open Digital Rights Language (ODRL).

14. The method of claim 11, further comprising the step of:
enabling, via a matching engine, a participant to request a new security with a set of rights specifications and further enabling the plurality of data producers to bid on creating the new security.

15. The method of claim 11, further comprising the step of:
automatically, via a computer processor, generating one or more derived or synthetic securities while respecting the rights of each of the plurality of data producers as expressed by one or more Digital Rights Management (DRM) rules.

16. The method of claim 14, wherein the bid from at least one of the plurality of data producers comprise one or more of: rights, requirements and prohibitions relating to creating the new security.

17. The method of claim 14, wherein the matching engine is configured to identify one or more missing rights.

18. The method of claim 17, in response to the one or more missing rights, the matching engine programmatically acquires the one or more missing rights.

19. The method of claim 14, wherein the matching engine enables one or more interactions between the participant and the plurality of data producers to determine one or more terms and conditions associated with the request for the new security.

20. The method of claim 19, wherein the matching engine generates a digital contract to capture the one or more terms and conditions.
